(19) United States
(12) Patent Application Publication
(10) Pub. No.: US 2007/0196672 A1
(43) Pub. Date: Aug. 23, 2007

(54) Perhydropolysilazane-containing coatings for metal and polymer surfaces

(76) Inventors: Stefan Brand, Hirschberg-Leutershausen (DE); Andreas Dierdorf, Hofheim (DE); Hubert Liebe, Wiesbaden (DE); Andreas Wacker, Mannheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/591,573

(22) PCT Filed: Feb. 22, 2005
(86) PCT No.: PCT/EP05/01827

§ 371 Date: Sep. 1, 2006

(30) Foreign Application Priority Data
Mar. 4, 2004 (DE) 10 2004 011 212.6

(51) Int. Cl. B32B 27/00; B05D 3/02; C08L 83/00; C08G 77/00

(52) U.S. Cl. 428/447; 427/387; 525/474

(57) ABSTRACT

The invention relates to a surface coating comprising at least one type of perhydropolysilazane of the formula I 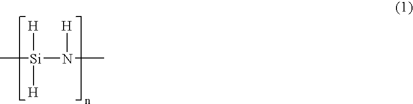 wherein n is an integer of a value such that the perhydropolysilazane number-average molecular weight of from 150 to 150 000 g/mol, a solvent and a catalyst and, possibly one or more cobinding agents. The hardened coating has thickness of at least 1 micrometer, preferably ranging from 2 to 20 micrometers. The inventive coating containing at least one type of perhydropolysilazane is suitable for protecting rims, in particular, aluminum rims.

The present invention relates to the perhydropolysilazane-based coating for producing an easy-to-clean protective coating for metal or plastic surfaces. Particularly good properties are exhibited by the coating as a protective coating for wheel rims, particularly for aluminum rims.

The use of aluminum wheel rims in automobile construction has increased greatly in recent years. On the one hand the lighter aluminum rims offer weight advantages over steel rims and so enable fuel savings, but the essential aspect is that aluminum rims are used above all for esthetic reasons, since they give the vehicle a high-value and refined appearance.

A disadvantage of aluminum rims is in particular their susceptibility to corrosion and their propensity to soiling. Moreover, scratches on the glossy surface of an aluminum rim are much more noticeable than on a steel rim. For this reason aluminum rims are provided at the end of the manufacturing operation with a coating, which is generally composed of a pretreatment of the aluminum (chromating or chromate-free), a primer, a pigmented base coat and, lastly, a clear coat. This complex coating is needed in order to ensure sufficient corrosion protection. In spite of the coating, corrosion causes problems, through the use, for example, of gritting salt in the winter. Finally brake dust which deposits on the aluminum rim over time likewise eats into the coating and can no longer be removed. Moreover, when snow chains are used, the aluminum rims are easily scratched. Another cause of scratches is the cleaning of the aluminum rims with abrasive tools, such as brushes or sponges. Also becoming more and more widespread are polished or bright-machined aluminum rims, whose surface consists of an esthetically appealing, glossy surface of pure aluminum, protected only by a thin clear coat, in order to retain the natural gloss of the aluminum. With this kind of rims the corrosion protection by means of the clear coat, which moreover ought to be as invisible as possible to the human eye, is very difficult to bring about.

WO 02/088269A1 describes the use of a perhydropolysilazane solution for producing hydrophilic, dirt-repellent surfaces. The description there includes that of use in the automobile sector (on the bodywork and the rims), and perhydropolysilazane solutions with a weight fraction of 0.3% to 2% are recommended. Example 1 there uses a highly dilute solution with a weight fraction of only 0.5% perhydropolysilazane, with which a very thin coating is obtained on steel, with a coat thickness of about 0.2 micrometer.

A coating so thin is first incapable of preventing scratching of the paint surface and is also incapable of ensuring sufficient corrosion protection or of preventing the eating-in of brake dust. Moreover, the thin coat is not enough to level the relatively inhomogeneous clear coat and to produce a truly smooth, glassy surface readily amenable to cleaning.

The object on which the present invention was based was to develop a coating with which it is possible to provide wheel rims with a hard, scratch-resistant coating which is easier to clean and which protects the aluminum rim against corrosion and against the eating-in of brake dust.

Surprisingly it has now been found that with a perhydropolysilazane solution it is possible to produce sufficiently thick protective coats which protect the rim against corrosion, scratching and eating-in of brake dust and also make it easier to clean the rim.

The invention accordingly provides a coating for surfaces, especially for metal and polymer surfaces, comprising at least perhydropolysilazane of the formula I 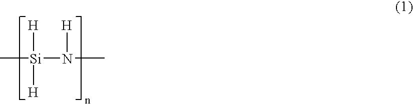
in which n is an integer and is such that the polysilazane has a number-average molecular weight of from 150 to 150 000 g/mol, and also a solvent and a catalyst and, if desired, one or more cobinders. The coating of the invention is especially suitable for producing an easy-to-clean protective coating on wheel rims, particularly aluminum rims.

The invention further provides for the use of the abovementioned coating comprising .at least one perhydropolysilazane of the formula I in a formulation which in addition to the perhydropolysilazane, the solvent and the catalyst comprises as additional constituent a cobinder, thereby further increasing the flexibility of the perhydropolysilazane without losing the properties such as the high scratch resistance, anti-corrosion effect and the scratch-resistant surface, for producing an easy-to-clean protective coating on wheel rims, particularly aluminum rims. The cured coating preferably has a thickness of at least 1 micrometer, more preferably 2 to 20 micrometers, very preferably 3 to 10 micrometers, and ensures sufficient protection against corrosion, scratching and the eating-in of brake dust on the rim, and also makes the rims easier to clean.

The cobinder may be either an organopolysilazane of the formula 2
—(SiR′R″—NR′″)ₙ— (2)
where R′, R″ and R′″ can be identical or different and are each either hydrogen or organic radicals, with the proviso that R′, R″ and R′″ must not simultaneously be hydrogen, and where n is such that the organopolysilazane has a number-average molecular weight of from 150 to 150 000 g/mol

or is another binder of very different type, such as is commonly used for producing coating materials, such as, for example, cellulose derivatives, such as cellulose acetobutyrate, polyesters or modified polyesters, phenolic or melamine resins, acrylates, epoxides or polyisocyanates.

Solvents suitable for the perhydropolysilazane formulation are, in particular, organic solvents which contain no water and also no reactive groups (such as hydroxyl groups or amine groups). These solvents are, for example, aliphatic or aromatic hydrocarbons, halogenated hydrocarbons, esters such as ethyl acetate or butyl acetate, ketones such as acetone or methyl ethyl ketone, ethers such as tetrahydrofuran or dibutyl ether, and also mono- and polyalkylene glycol dialkyl ethers (glymes), or mixtures of these solvents. A further possible constituent of the perhydropolysilazane formulation may comprise additives, which influence, for example, formulation viscosity, substrate wetting, film formation or the flash-off characteristics, or organic and inorganic UV absorbers.

The coating of the invention contains 1% to 40% by weight of at least one perhydropolysilazane of the formula (I), in particular 5% to 30%, preferably 10% to 20% by weight, and 0.001% to 5%, preferably 0.01% to 2%, by weight of a catalyst.

Suitable catalysts are N-heterocyclic compounds, such as 1-methylpiperazine, 1-methylpiperidine, 4,4′-trimethylenedipiperidine, 4,4′-trimethylene(1-methylpiperidine), diazabicyclo(2.2.2)octane and. cis-2,6-dimethylpiperazine.

Further suitable catalysts are mono-, di- and trialkylamines such as methylamine, dimethylamine, trimethylamine, phenylamine, diphenylamine and triphenylamine, DBU (1,8-diazabicyclo(5.4.0)-7-undecene), DBN (1,5-diazabicyclo(4.5.0)-5-nonene), 1,5,9-triazacyclododecane and 1,4,7-triazacyclononane.

Further suitable catalysts are organic and inorganic acids such as acetic acid, propionic acid, butyric acid, valeric acid, maleic acid, stearic acid, hydrochloric acid, nitric acid, sulfuric acid, phosphoric acid, chloric acid and hypochlorous acid.

Further suitable catalysts are metal carboxylates of the formula (RCOO)ₙM of saturated and unsaturated, aliphatic or alicyclic C₁-C₂₂ carboxylic acids and metal ions such as Ni, Ti, Pt, Rh, Co, Fe, Ru, Os, Pd. Ir, and Al; n is the charge of the metal ion.

Further suitable catalysts are acetylacetonate complexes of metal ions such as Ni, Pt, Pd, Al and Rh.

Further suitable catalysts are metal powders such as Au, Ag, Pd or Ni with a particle size of from 20 to 500 nm.

Further suitable catalysts are peroxides such as hydrogen peroxide, metal chlorides and organometallic compounds such as ferrocenes and zirconocenes.

The coating with the polysilazane formulation may take place by means of processes such as are conventionally employed in surface coating. The process in question may be, for example, spraying, dipping or flow coating. Afterward there may be a thermal aftertreatment, in order to accelerate the curing of the coating. Depending on the perhydropolysilazane formulation used and catalyst, curing takes place even at room temperature, but can be accelerated by heating.

Before the coating is applied it is possible first to apply a primary coat in order, for example, to improve the adhesion.

The invention therefore further provides a process for producing a protective coat on a wheel rim, the polysilazane solution with or without cobinder(s) being applied to the rim by suitable methods such as spraying or dipping, for example, and subsequently cured.

The cured coating has a thickness of at least 1 micrometer, preferably 2 to 20 micrometers, more preferably 3 to 10 micrometers, and ensures outstanding protection of the surfaces against corrosion and scratching. On rims coated in this way the eating-in of brake dust is prevented and cleaning is made considerably easier.

The coating of the invention can also be applied to already coated surfaces, such as to rims to which a clear coat has already been applied, for example, in order to provide the rim with additional protection against scratching, corrosion or the eating-in of brake dust. Additionally there is an increase, following the application of the coating, in the gloss as compared with the clear coat.

An alternative possibility is to do without the clear coat and to apply the coating directly to the pigmented base coat, which allows a saving to be made of one coating step.

In the case of nonprecoated materials, such as polished or bright-machined aluminum rims, for example, the perhydropolysilazane solution can also be used as a single protective coat, replacing the clear coat normally employed.

Thus it is possible to produce a protective coat which has a much lower thickness than the conventional coats, in conjunction with lower consumption of material and lower emission of solvents, and which additionally has properties superior to those of the conventional coatings.

Because of the high reactivity of the perhydropolysilazane the coating cures in principle even at room temperature or below, but its curing can be accelerated by an increase in temperature. The coating is preferably cured at a temperature in the range from 10 to 200° C., in particular 25 to 160° C., preferably 80 to 150′.C. The maximum possible curing temperature depends essentially on the substrate to which the coating is applied. In the case of metals such as aluminum relatively high temperatures are possible, 180 to 200° C. or more. If the coating is applied to a coat which is already present (either base coat or clear coat), it is advisable to work at a lower temperature, so that the underneath coat does not soften, preferably at 25 to 160° C., more preferably at 80 to 150° C.

The curing of the coating is also affected by the atmospheric humidity. At relatively high humidity curing takes place more rapidly, which can be an advantage; conversely, curing in an atmosphere with only low humidity, such as in a drying cabinet, entails a slow and uniform curing process. Curing of the coating of the invention can therefore take place at a relative atmospheric humidity of from 0 to 100%.

Coating with the perhydropolysilazane formulation may be followed by further aftertreatment, which adapts the surface energy of the coating. In this way it is possible to produce either hydrophilic or hydrophobic surfaces, which influence the soiling tendency.

### EXAMPLES

The perhydropolysilazanes used are products from Clariant Japan K.K. The average molar mass of the perhydropolysilazane is approximately 2000 g/mol. NP110-20 is a 20% strength solution of perhydropolysilazane in xylene, containing 4,4′-trimethylene-bis(1-methylpiperidine) as catalyst. NL120A-20 is a 20% strength solution of perhydropolysilazane in dibutyl ether, containing palladium propionate as catalyst. NP 140-005 is a 0.5% strength solution of perhydropolysilazane in xylene and Pegasol AN 45, containing 4,4′-trimethylenebis(1-methylpiperidine) as catalyst. In the examples below, parts and percentages are by weight. The aluminum rims are standard commercial aluminum rims such as may be obtained via the auto accessory trade, or parts of these rims obtained by sawing from whole rims, or metal test panels consisting of appropriate material. Coating was carried out either by spraying with a standard commercial spray gun or by dipping in a standard commercial dipping apparatus.

### Comparative Example 1

An unpretreated aluminum sheet of alloy AlMgSi 0.5 is coated by spraying with 0.5% strength perhydropolysilazane solution NP 140-005 (Clariant Japan). To cure the coating it is left for 5 days at room temperature and customary atmospheric humidity before tests are carried out. The result is a coating with a layer thickness of 0.2 μm.

### Example 1

### Coating of an Aluminum Rim by Spraying

A standard commercial aluminum rim such as may be obtained via the automobile assessory trade is coated by spraying with a solution consisting of 97 parts of 20% strength perhydropolysilazane solution NP110-20 (Clariant Japan), 2.4 parts of Tego Protect 5001 (Tego Chemie), 0.5 part of Byk 411 and 0.1 part of Byk 333 (Byk-Chemie). The rim is then left in the air for about 10 minutes, for evaporation, and subsequently dried at 80° C. for 60 minutes. The result is a clear, transparent and crack-free coating on the surface. The gloss of the coated rim has increased by 5 gloss units in comparison to the uncoated rim.

### Example 2

### Coating of a Coated Metal Sheet With Base Coat and Clear Coat by Dipping

A coated aluminum sheet which has been provided with a standard commercial pigmented base coat and a clear coat is immersed in a dipping apparatus which is filled with a solution consisting of 97 parts of 20% strength perhydropolysilazane solution NP100-20 (Clariant Japan), 2.4 parts of Tego Protect 5001 (Tego Chemie), 0.5 part of Byk 411 and 0.1 part of Byk 333 (Byk-Chemie) and is withdrawn at a speed of 120 cm/min. The sheet is subsequently left in air for about 10 minutes, for evaporation, and then dried at 80° C. in a drying cabinet for 60 minutes. The result is a clear, transparent and crack-free coating.

### Example 3

### Coating of a Polished Aluminum Sheet by Spraying

A polished aluminum sheet is coated by spraying with a 20% strength perhydropolysilazane solution NLI 110A-20 (Clariant Japan). It is subsequently left in air for about 10 minutes, for evaporation, and then dried at 130° C. for 60 minutes. The result is a clear, transparent, crack-free coating.

### Example 4

### Coating of a Polished Aluminum Sheet by Dipping

A polished aluminum sheet is immersed in a dipping apparatus which is filled with a 20% strength perhydropolysilazane solution NL 110A-20 (Clariant Japan) and is withdrawn at a speed of 120 cm/min. The sheet is subsequently left in air for about 10 minutes, for evaporation, and dried at 180° C. in a drying cabinet for 60 minutes. The result is a clear, transparent and crack-free coating.

### Example 5

### Coating of a Polished Aluminum Sheet by Spraying

A polished aluminum sheet is coated by spraying with a solution consisting of 100 parts of 20% strength perhydropolysilazane solution NL 110A-20 (Clariant Japan) and 3.5 parts of polymethylpolysilazane. It is subsequently left in air for about 10 minutes, for evaporation, and then dried at 130° C. for 60 minutes. The result is a clear, transparent, crack-free coating.

### Example 6

### Corrosion Test

An unpretreated aluminum sheet of the alloy AlMgSi 0.5 is coated by spraying with a 20% strength perhydropolysilazane solution NP110-20 (Clariant Japan). It is subsequently left in the air for about 10 minutes, for evaporation, and dried at 130° C. for 60 minutes. The result is a clear, transparent, crack-free coating having a layer thickness of 2.6 μm. A number of metal sheets obtained in this way are subjected to a salt spray test in accordance with ISO 7253 and to a condensation water test in accordance with ISO 6270. Neither in the salt spray test nor in the condensation water test, after 1000 h, are there are any traces of corrosion, whereas an uncoated control sheet has undergone severe corrosion. The coated sheet from comparative example 1 shows distinct traces of corrosion.

### Example 7

### Dirt Repellency Effect

A coated aluminum rim from example 1 is mounted on the front axle of a standard commercial automobile. On the other side there is a rim of the same type which has not been provided with the additional inventive coating. The automobile is then driven for several thousand kilometers under everyday conditions. During this time the soiling tendency of the rims is examined at regular intervals. In the course of such examination it is found that the coated rim is substantially cleaner than the uncoated control rim. When an attempt is made to clean the rims the dirt can be removed simply with a paper cloth or with a water jet on the coated rim, whereas this is not possible on the uncoated rim. No eating-in of brake dust is observed on the coated rim, while on the uncoated rim, over time, black flecks are observed which are very difficult if not impossible to remove by cleaning.

### Example 8

### Determination of the Scratch Resistance

The scratch resistance is determined by multiple loading (five back-and-forth strokes) with a 00-grade steel wool, with a force of 3 N. The scratching is evaluated visually in. accordance with the following scale: very good (no scratches), good (few scratches), satisfactory (distinct scratches), adequate (severely scratched) and deficient (very severely scratched).

| Example | Scratch resistance |
|---|---|
| Comparative example 1 | satisfactory |
| 1 | very good |
| 2 | good |
| 3 | very good |
| 4 | very good |
| 5 | very good |
| Control (uncoated rim) | adequate |

1. A coating for a surface, comprising 10-20% by weight of perhydropolysilazane of the formula 1 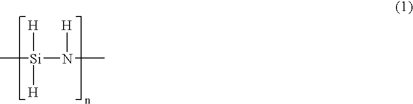
where n is an integer and is such that the perhydropolysilazane has a number-average molecular weight of from 150 to 150 000 g/mol, a solvent and a catalyst and, optionally, one or more cobinders₁ and the coating, when cured, has a thickness of from 2 to 20 micrometers.

2. The coating as claimed in claim 1, wherein the one or more cobinders is an organopolysilazane of the formula 2
—(SiR′R″—NR′″)ₙ— (2)
where R′, R″ and R′″ are identical or different and are each either hydrogen or unsubstituted or substituted organic radicals, with the proviso that R′, R″ and R′″ can not all be hydrogen, and where n is such that the organopolysilazane has a number-average molecular weight of from 150 to 150 000 g/mol, with the proviso that the mass fraction of the organopolysilazane, based on the perhydropolysilazane, is at least 1% and not more than 100%.

3. The coating as claimed in claim 1, wherein the mass fraction of the one or more cobinders, based on the perhydropolysilazane, is at least 1% and not more than 100%.

4. The coating as claimed in claim 3, wherein the one or more cobinders is a cellulose derivative, a polyester, a modified polyester, a phenolic resin, a melamine resin, an acrylate, epoxide or polyisocyanate.

5. The coating as claimed in claim 1, further comprising 0.001% to 5% by weight of a catalyst.

6. The coating as claimed in claim 5, wherein the catalyst is an N-heterocyclic compound, a mono-, di- or trialkylamine, an organic or inorganic acid, a peroxide, a metal carboxylate, an acetylacetonate complex, metal powder or an organometallic compound.

7. A method for protecting a substrate having a surface comprising the step of applying a coating as claimed in claim 1 to the surface and curing the coating to the surface.

8. The method as claimed in claim 7, wherein the surface is a metal or polymer surface.

9. The method as claimed in claim 7, wherein the coating, when cured, has a thickness of from 3 to 10 micrometers.

10. The method as claimed in 7, wherein the substrate is a wheel rim.

11. A process for producing a protective coating on metal or plastic surface, wherein the surface may have already been coated, comprising the steps of applying a coating as claimed in claim 1 to the surface and curing the coating at a temperature of from 10 to 200° C.

12. The coating as claimed in claim 2, wherein the mass fraction of the organopolysilazane, based on the perhydropolysilazane, is 10% to 70%.

13. The coating as claimed in claim 2, wherein the mass fraction of the organopolysilazane, based on the perhydropolysilazane, is 15% to 50%.

14. The coating as claimed in claim 1, wherein the mass fraction of the one or more cobinders, based on the perhydropolysilazane, is 10% to 70%.

15. The coating as claimed in claim 1, wherein the mass fraction of the one or more cobinders, based on the perhydropolysilazane, is 20% to 50%.

16. The method as claimed. in claim 10, wherein the wheel rim is an aluminum rim.

17. The process as claimed in claim 11, wherein the curing step occurs at a temperature between 25 to 160° C.

18. The process as claimed in claim 11, wherein the curing step occurs at a temperature between 80 to 150° C.

19. A metal or plastic surface having a protective coating thereon according to claim 11.

20. A coating for a surface, comprising at least one perhydropolysilazane of the formula 1 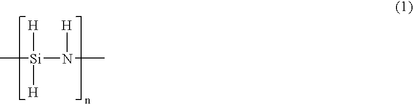
where n is an integer and is such that the perhydropolysilazane has a number-average molecular weight of from 150 to 150 000 g/mol, a solvent and a catalyst and, optionally, one or more cobinders, and the coating, when cured, has a thickness of from 2 to 20 micrometers.

21. The coating as claimed in claim 20, wherein the coating, when cured, has a thickness of 2 to 20 micrometers.

22. The coating as claimed in claim 20, wherein the coating, when cured, has a thickness of 3 to 10 micrometers.

23. A surface coated with the coating according to claim 20, wherein the surface is a metal or plastic.

24. The surface as claimed in claim 23, wherein the surface is the surface of a wheel rim.

25. A wheel rim having a surface coated with the coating of claim 20.

26. A wheel rim having a surface coated with the coating of claim 1.

27. The wheel rim as claimed in claim 25, wherein the wheel rim is an aluminum wheel rim.

28. The wheel rim as claimed in claim 26, wherein the wheel rim is an aluminum wheel rim.
